(19) United States
(12) Patent Application Publication
(10) Pub. No.: US 2022/0309333 A1
(43) Pub. Date: Sep. 29, 2022

(54) UTILIZING NEURAL NETWORK MODELS TO DETERMINE CONTENT PLACEMENT BASED ON MEMORABILITY

(71) Applicant: Accenture Global Solutions Limited, Dublin (IE)

(72) Inventors: Christian SOUCHE, Cannes (FR); Edouard MATHON, Antibes (FR); Ji TANG, Valbonne (FR)

(21) Appl. No.: 17/210,155

(22) Filed: Mar. 23, 2021

(51) Int. Cl. G06N 3/08; G06N 3/04

(52) U.S. Cl. CPC G06N 3/08; G06N 3/0454

(57) ABSTRACT

A device may receive digital content and target user category data identifying target users of the digital content and may modify features of the digital content to generate a plurality of content data. The device may select a neural network model, from a plurality of neural network models, based on the target user category data, and may process the plurality of content data, with the neural network model, to determine first memorability scores for the plurality of content data. The device may process a plurality of areas of the plurality of content data, with the neural network model, to determine second memorability scores for the plurality of areas. The device may perform actions based on the first memorability scores or the second memorability scores.

### BACKGROUND

Memorability may indicate a likelihood that an image will be remembered by a user (e.g., by being stored in a short-term memory or a long-term memory of the user). A memorability score of the image may correspond to a percentage of users that remember the image after the image has been presented multiple times. The memorability score may be used to determine a measure of effectiveness of the image with respect to the users.

### SUMMARY

In some implementations, a method may include receiving digital content and target user category data identifying target users of the digital content and modifying one or more features of the digital content to generate a plurality of content data based on the digital content. The method may include selecting a neural network model, from a plurality of neural network models, based on the target user category data, and processing the plurality of content data, with the neural network model, to determine first memorability scores for the plurality of content data. The method may include processing a plurality of areas of the plurality of content data, with the neural network model, to determine second memorability scores for the plurality of areas. The method may include performing one or more actions based on the first memorability scores or the second memorability scores.

In some implementations, a device includes one or more memories and one or more processors to receive digital content and target user category data identifying target users of the digital content, and modify one or more features of the digital content to generate a plurality of content data based on the digital content, wherein the one or more features include one or more of: a contrast of the digital content, a color of the digital content, a saturation of the digital content, a size of the digital content, or a position of the digital content. The one or more processors may select a neural network model, from a plurality of neural network models, based on the target user category data, and may process the plurality of content data, with the neural network model, to determine first memorability scores for the plurality of content data. The one or more processors may process a plurality of areas of the plurality of content data, with the neural network model, to determine second memorability scores for the plurality of areas. The one or more processors may perform one or more actions based on the first memorability scores or the second memorability scores.

In some implementations, a non-transitory computer-readable medium may store a set of instructions that includes one or more instructions that, when executed by one or more processors of a device, cause the device to receive digital content and target user category data identifying target users of the digital content, and modify one or more features of the digital content to generate a plurality of content data based on the digital content. The one or more may cause the device to select a neural network model, from a plurality of neural network models, based on the target user category data, and process the plurality of content data, score settings, and category data, with the neural network model, to determine first memorability scores for the plurality of content data, wherein the score settings include at least one of an exposure time for the digital content or a time interval between two exposures of the digital content, and wherein the category data includes data identifying a category of the digital content. The one or more may cause the device to process a plurality of areas of the plurality of content data, the score settings, and the category data, with the neural network model, to determine second memorability scores for the plurality of areas. The one or more may cause the device to perform one or more actions based on the first memorability scores or the second memorability scores.

### BRIEF DESCRIPTION OF THE DRAWINGS

FIGS. 1A-1F are diagrams of an example implementation described herein.

FIG. 2 is a diagram illustrating an example of training and using a machine learning model in connection with determining content placement based on memorability.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing neural network models to determine content placement based on memorability.

### DETAILED DESCRIPTION

The following detailed description of example implementations refers to the accompanying drawings. The same reference numbers in different drawings may identify the same or similar elements.

Businesses use one or more image processing techniques to generate and provide images to users. The one or more image processing techniques utilize computing resources, networking resources, among other resources. Businesses also use computing resources, networking resources, among other resources to calculate memorability scores for the images in an effort to quantify the memorability of the images.

Current techniques for calculating memorability scores calculate a fixed memorability score for an image based on a predefined rule, a fixed image exposure time (or a fixed amount of time during which the image is displayed), and/or a fixed time interval between exposures of the image. The fixed memorability score is expected to be applicable to different user categories. However, a memorability of the image for a first user category (e.g., a ten-year-old boy) may be different than a memorability of the image for a second user category (e.g., a seventy-year-old woman). Therefore, the fixed memorability score, calculated for the image, may not account for a difference in the memorability between the different user categories.

Therefore, current techniques for calculating memorability scores waste computing resources (e.g., processing resources, memory resources, communication resources, among other examples), networking resources, and/or other resources associated with using one or more image processing techniques to generate images that are not memorable, using the one or more image processing techniques to alter the images when the images are not memorable, using one or more image processing techniques to generate additional images, searching sources of digital content for images that are memorable, among other examples.

Some implementations described herein relate to a content system that utilizes neural network models to determine content placement based on memorability. For example, the content system may receive digital content and target user category data identifying target users of the digital content and may modify one or more features of the digital content to generate a plurality of content data based on the digital content. The content system may select a neural network model, from a plurality of neural network models, based on the target user category data, and may process the plurality of content data, with the neural network model, to determine first memorability scores for the plurality of content data. In some examples, the first memorability score, for particular content data (e.g., generated based on modifying the one or more features of the digital content), may indicate a likelihood of one or more target users (of a target user category) remembering the particular content data after viewing the particular content data.

The content system may process a plurality of areas of the plurality of content data, with the neural network model, to determine second memorability scores for the plurality of areas. In some examples, the second memorability score, for a particular area, may indicate a likelihood of the one or more target users remembering the particular area (e.g., remembering content in the particular area) after viewing the particular area.

The content system may perform one or more actions based on the first memorability scores or the second memorability scores. For example, based on the first memorability scores, the content system may provide information identifying one or more changes to the one or more features (of the digital content) to increase a likelihood of the one or more target users remembering the digital content. Additionally, or alternatively, based on the second memorability scores, the content system may provide information identifying one or more recommended areas (in the digital content) for placing content (e.g., placing a logo, placing a graphical object, among other examples).

As described herein, the content system utilizes neural network models to determine content placement based on memorability. The content system may calculate a memorability score of digital content based on a user category (e.g., age, gender, job description, level of education, among other examples), a content category identified by the digital content (e.g., content related to a good, content related to a service, among other examples), an exposure time associated with exposing (or presenting) the digital content to target users, a time interval between exposures, among other examples. The content system may provide, as input to a pre-trained neural network model, data (e.g., regarding the user category, the category identified by digital content, the exposure time, the time interval, among other examples) and utilize the pre-trained neural network model to calculate the memorability score of the digital content based on the data. By calculating the memorability score of the digital content as described herein, the content system conserves computing resources, networking resources, and/or other resources that would otherwise have been consumed by using one or more image processing techniques to generate images that are not memorable, using the one or more image processing techniques to alter the images when the images are not memorable, using one or more image processing techniques to generate additional images, searching sources of digital content for images that are memorable, among other examples.

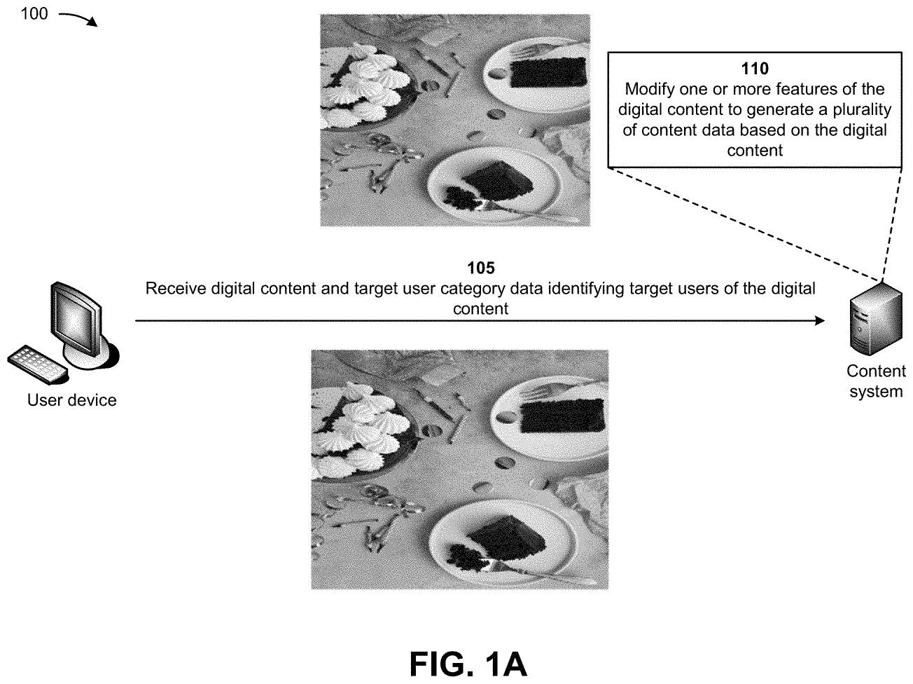

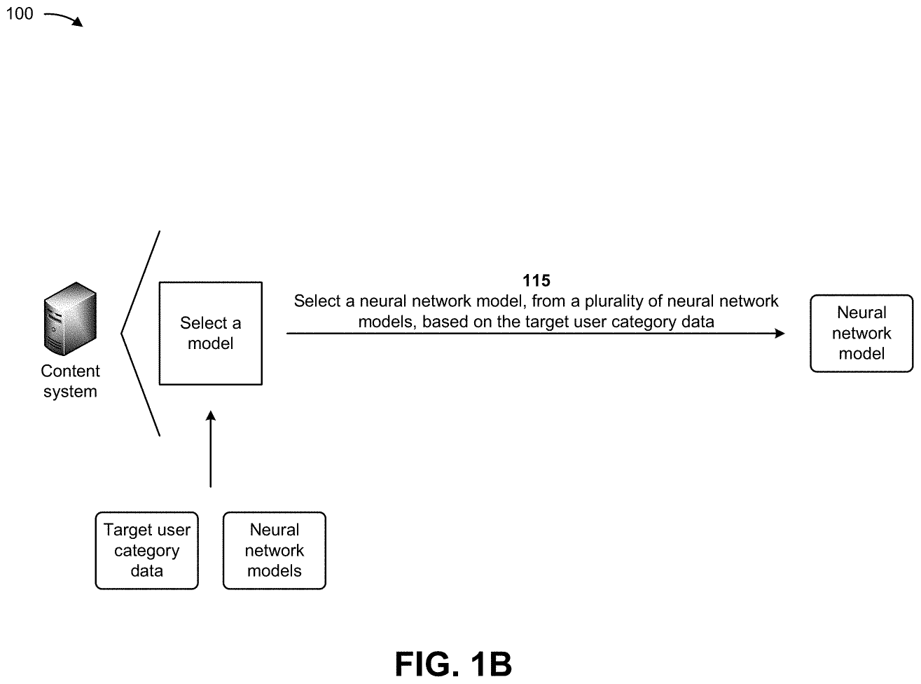

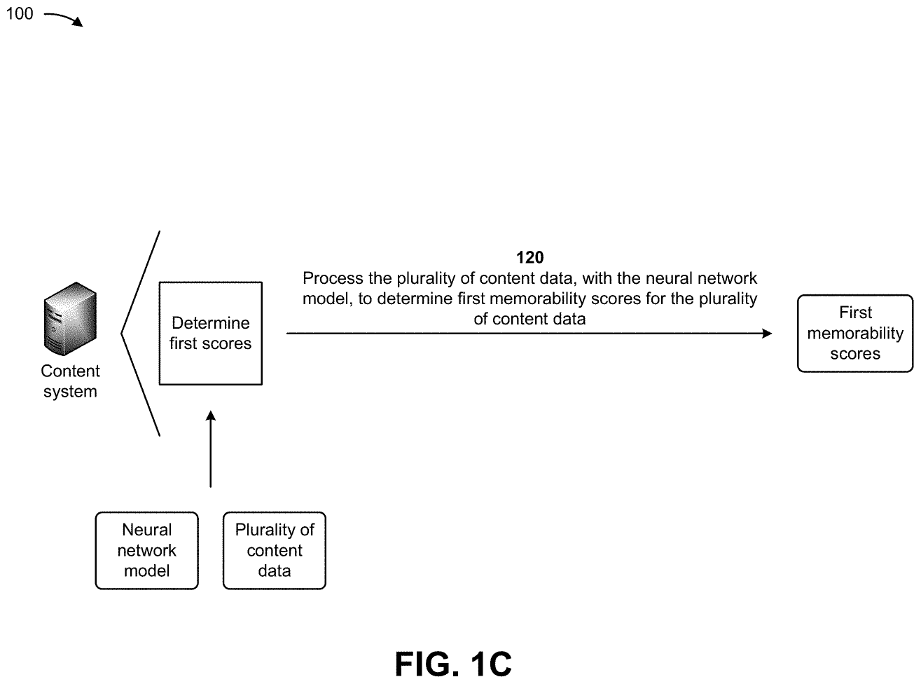

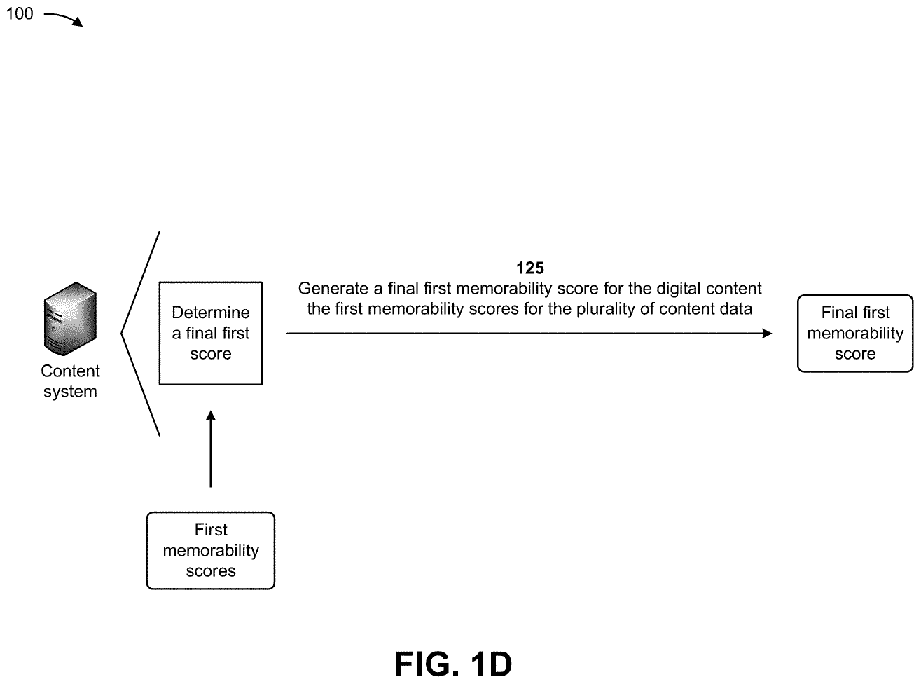

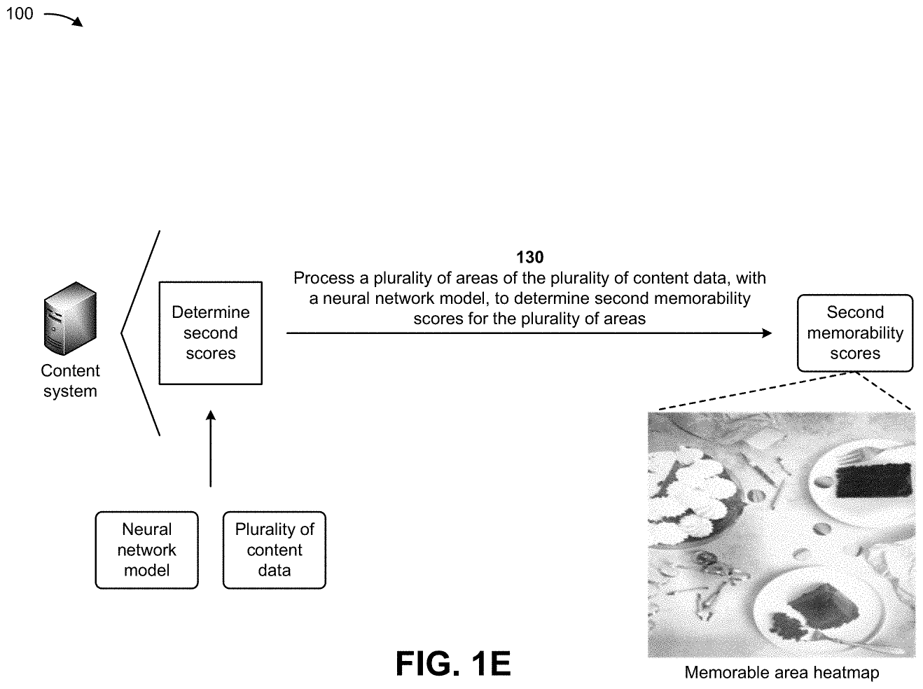

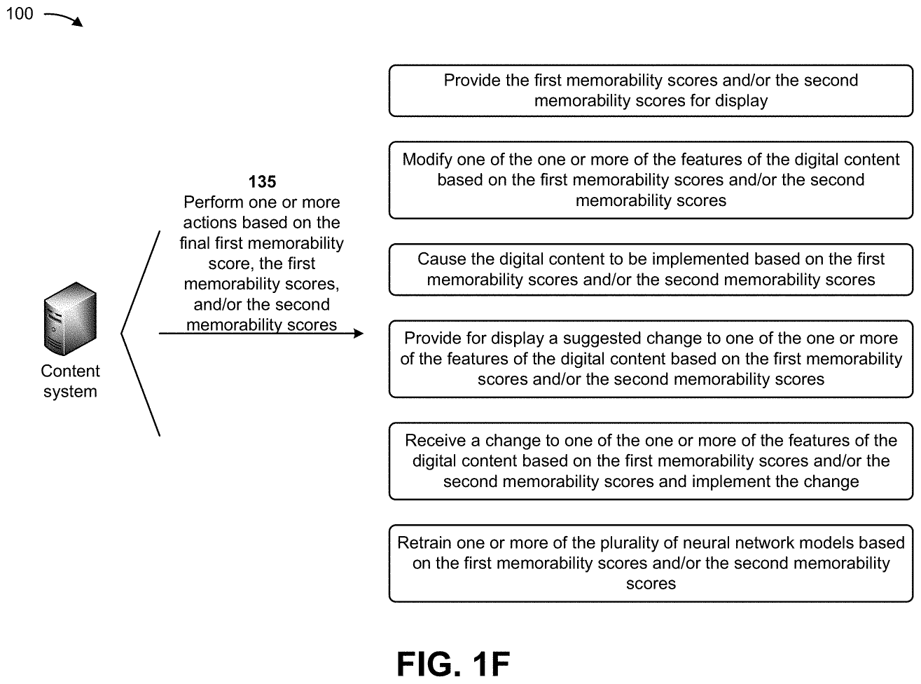

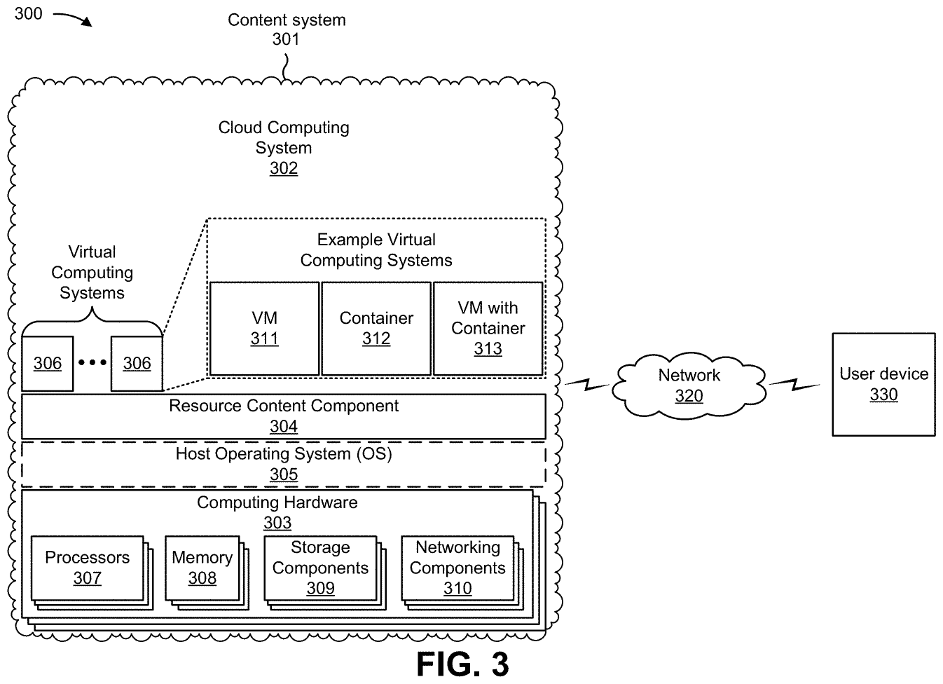

FIGS. 1A-1F are diagrams of an example implementation 100 described herein. As shown in FIGS. 1A-1F, example 100 includes a user device and a content system. The user device may include a laptop computer, a mobile telephone, a desktop computer, among other examples. The content system may include one or more devices that utilize neural network models to determine content placement based on memorability. The user device and the content system are described in more detail below in connection with FIG. 3.

In the example that follows, assume that a user, of the user device, desires to improve a measure of memorability of digital content with respect to target users. The user may include an administrator of a website, an administrator of a social media site, an administrator of a social media application, an administrator of video content (e.g., television content, video on demand content, or online video content), among other examples. The memorability (of the digital content) may indicate a likelihood of the digital content being remembered by the target users. The digital content may include an image, a video, textual information, among other examples. In some implementations, the digital content may be obtained from a website, a thumbnail image, a poster, a social media post, among other examples.

As shown in FIG. 1A, and by reference number 105, the content system may receive the digital content and target user category data identifying the target users of the digital content. In some examples, the content system may receive (e.g., from the user device) a request to improve the measure of memorability of the digital content and may receive the digital content and the target user category data as part of the request. In some examples, the content system may receive the digital content and the target user category data periodically.

The target user category data may identify a particular target user category by specifying, for example, data identifying one or more ages of the target users, data identifying one or more genders of the target users, data identifying one or more job descriptions of the target users, data identifying one or more levels of education of the target users, data identifying one or more levels of income of the target users, data identifying one or more geographical locations of the target users, among other examples. In this regard, the target user category data may identify different target user categories such as female target users, male target users, female target users of a particular age or of a particular range of ages, male target users of a particular age or of a particular range of ages, female target users of a particular age or of a particular range of ages and located in a particular geographical location, among other examples. In some examples, the user device may provide the digital content and the target user category data to cause the content system to determine a manner to improve the measure of memorability of the digital content with respect to the different target user categories.

As shown in FIG. 1A, and by reference number 110, the content system may modify one or more features of the digital content to generate a plurality of content data based on the digital content. In some examples, the content system may modify the one or more features of the digital content to improve the measure of memorability of the digital content as explained herein. In some implementations, the content system may be pre-configured with information identifying features to be modified to improve memorability and may identify the one or more features based on the information identifying features. Additionally, or alternatively, the content system may identify the one or more features based on data (e.g., historical and/or current) that includes feature data regarding features (of other digital content) that were modified by the content system.

In some implementations, the one or more features (identified by the content system) may include a contrast of the digital content, a color of the digital content, a saturation of the digital content (e.g., a color saturation of the digital content), a size of the digital content (e.g., a height and/or a width of the digital content and/or an aspect ratio of the digital content), a position of one or more portions of the digital content, a sharpness of the digital content, a brightness of the digital content, a blurriness of the digital content, among other examples. In this regard, when modifying the one or more features of the digital content, the content system may modify the contrast of one or more portions of the digital content to generate first content data, modify the color of one or more portions of the digital content to generate second content data, modify the saturation of one or more portions of the digital content to generate third content data, modify the size of the digital content to generate fourth content data, modify the position of one or more portions of the digital content to generate fifth content data, modify a combination of the features to generate sixth content data, and so on.

In some implementations, the content system may use one or more image processing techniques to modify pixels of the digital content (e.g., modify pixel values of the digital content). In some implementations, the content system may determine a manner (in which the one or more features are to be modified) based on the feature data. As an example, the feature data may include information identifying a manner in which the features (of the other digital content) were modified. The content system may cause the one or more features to be modified in a same or in a similar manner. The plurality of content data may include one or more of the first content data, the second content data, the third content data, the fourth content data, the fifth content data, the sixth content data, and so on. The first content data, the second content data, the third content data, the fourth content data, the fifth content data, and/or the sixth content data may include an image, a video, textual information, among other examples.

In some implementations, the content system may identify the one or more portions using one or more image classification techniques (e.g., a Convolutional Neural Networks (CNNs) technique, a residual neural network (ResNet) technique, a Visual Geometry Group (VGG) technique) and/or an object detection technique (e.g., a Single Shot Detector (SSD) technique, a You Only Look Once (YOLO) technique, and/or a Region-Based Fully Convolutional Networks (R-FCN) technique). In some examples, the one or more portions may include one or more areas of the digital content (e.g., a top-right area, a bottom half area, a center area, or an entire area), one or more logos present in the digital content, one or more graphical objects in the digital content, among other examples.

In some implementations, the first content data may include one or more images generated based on modifying the contrast to one or more contrast values of a range of contrast values, the second content data may include one or more images generated based on modifying the color to one or more colors of a range of colors, the third content data may include one or more images generated based on modifying the saturation to one or more saturation values of a range of saturation values, the fourth content data may include one or more images generated based on modifying the size to one or more sizes of a range of sizes, the fifth content data may include one or more images generated based on modifying the position to one or more positions of a range of positions, and so on.

As shown in FIG. 1B, and by reference number 115, the content system may select a neural network model, from a plurality of neural network models, based on the target user category data. The plurality of neural network models may be trained to predict measures of memorability (e.g., memorability scores) of different digital content for different user categories. For example, the plurality of neural network models may include a first neural network model trained to predict memorability scores for a first user category, a second neural network model trained to predict memorability scores for a second user category, and so on.

In some implementations, the content system may search, using the target user category data, information regarding the plurality of neural network models. As an example, the content system may search the information regarding the plurality of neural network models using information identifying the particular target user category. In some instances, the information identifying the particular target user category may match the first user category for which the first neural network model has been trained. Additionally, or alternatively, the information identifying the particular target user category may match a subset of the second user category for which the second neural network model has been trained. By way of example, assume that the particular target user category is female users of ages 10-20 and that the plurality of neural network models include a neural network model trained for female users of ages 10-20. The content system may identify and select the neural network model trained for female users of ages 10-20.

By way of another example (with respect to the same particular target user category), assume that the plurality of neural network models include a first neural network model trained for female users of ages 15-20 and a second neural network model trained for male users of ages 15-20. The content system may identify and select the first neural network model trained for female users of ages 15-20 because the user category (of the selected neural network model) partially matches the particular target user category.

By way of another example (with respect to the same particular target user category), assume that the plurality of neural network models include a first neural network model trained for female users of ages 5-14 and a second neural network model trained for female users of ages 15-25. The content system may identify and select the first neural network model trained for female users of ages 5-14 and/or the second neural network model trained for female users of ages 15-25 because the user categories (of the selected neural network models) partially match the particular target user category.

Based on the foregoing, the content system may search the information regarding the plurality of neural network models, using information identifying a first user category (e.g., a first subset of the particular target user category), to identify and select a first neural network model that has been trained to predict memorability scores for the first user category (or a subset of the first user category); search the information regarding the plurality of neural network models, using information identifying a second user category (e.g., a second subset of the particular target user category), to identify and select a second neural network model that has been trained to predict memorability scores for the second user category (or a subset of the second user category); and so on.

A neural network model (selected by the content system) may include a residual neural network (ResNet) model, a deep learning technique (e.g., a faster regional convolutional neural network (R-CNN)) model, a feedforward neural network model, a radial basis function neural network model, a Kohonen self-organizing neural network model, a recurrent neural network (RNN) model, a convolutional neural network model, a modular neural network model, a deep learning image classifier neural network model, a Convolutional Neural Networks (CNNs) model, among other examples.

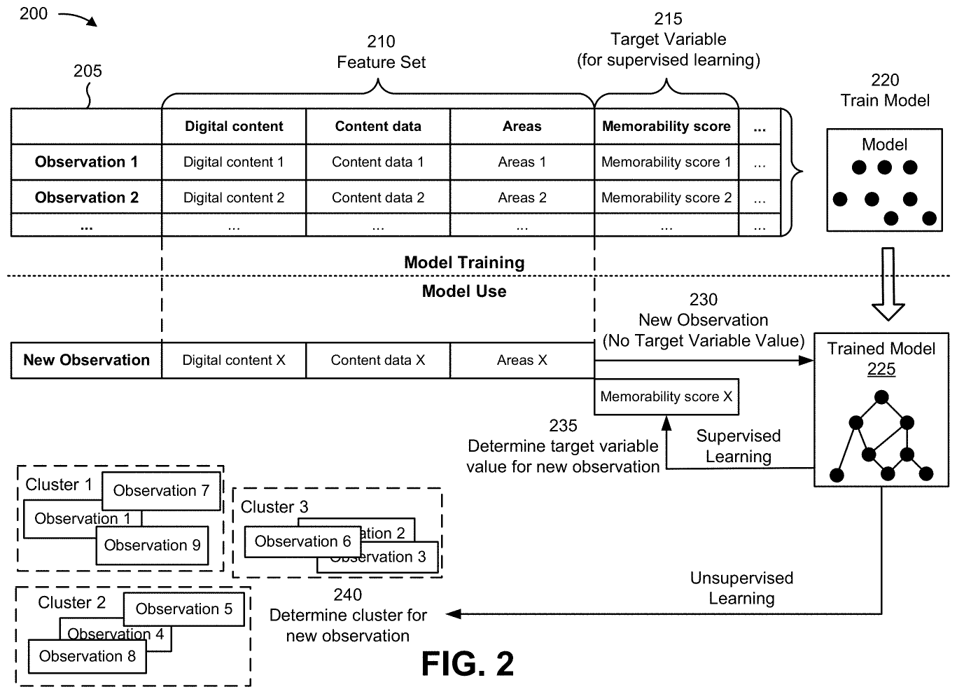

In some implementations, the neural network model may be trained using training data (e.g., historical and/or current) as described below in connection with FIG. 2. In some examples, the training data may include different digital content, data regarding features of the different digital content, data identifying a user category, content category data regarding categories (e.g., of content) identified by the different digital content, data regarding different exposure times for the different digital content to users associated with the user category, time interval between exposures of the different digital content, information indicating whether the users remembered the different digital content, information identifying areas of the different digital content remembered by the users (e.g., a top-right area, a bottom half area, a center area, and/or an entire area), among other examples. The categories (identified by the different digital content) may include goods, services, among other examples. The exposure time may refer to a period of time during which the different digital content is exposed (or presented) to the users.

The content system may train the neural network model in a manner similar to the manner described below in connection with FIG. 2. Alternatively, rather than training the neural network model, the content system may obtain the neural network model from another system or device that trained the neural network model. In this case, the other system or device may obtain the training data (discussed above) for use in training the neural network model, and may periodically receive additional data that the other system or device may use to retrain or update the neural network model.

As shown in FIG. 1C, and by reference number 120, the content system may process the plurality of content data, with the neural network model, to determine first memorability scores for the plurality of content data. For example, the content system may provide the plurality of content data as an input to the neural network model and the neural network model may determine (or predict), as an output, the first memorability scores for the plurality of content data. When the content system selects multiple neural network models, as described above, the content system may provide the plurality of content data as an input to each of the multiple neural network models and each of the multiple neural network models may determine (or predict), as an output, respective first memorability scores for the plurality of content data.

The content system may provide the first content data as an input to the neural network model and may use the neural network model to determine one or more first memorability scores for the first content data (e.g., one or more first memorability scores for the one or more images associated with the one or more contrast values), may provide the second content data as an input to the neural network model and may use the neural network model to determine one or more first memorability scores for the second content data (e.g., one or more first memorability scores for the one or more images associated with the one or more colors), and so on. When the content system selects multiple neural network models, as described above, the content system may perform the above operations for each of the multiple neural network models. The processing with the multiple neural network models may be performed concurrently, successively, partially concurrently, or partially successively.

The content system may use the neural network model to determine first memorability scores for each change to the one or more features or for different combinations of changes to the one or more features of the digital content (e.g., a memorability score for modifying the contrast and the color, a memorability score for modifying the size, the contrast, and the saturation, among other examples). When the content system selects multiple neural network models, as described above, the first memorability scores determined by a first one of the multiple neural network models may be different than the first memorability scores determined by a second one of the multiple neural network models for the same feature changes or same combination of feature changes.

In some implementations, the input to the neural network model may include content category data in addition to the plurality of content data. For example, the content system may provide the plurality of content data and the content category data as input to the neural network model and may use the neural network model to determine first memorability scores in a manner similar to the manner described above. The content category data may identify one or more categories of content identified by the digital content. The one or more categories of content may include one or more categories of goods, one or more categories of services, among other examples.

In some examples, the content system may use one or more of the image processing techniques (discussed above) to analyze the digital content. Based on analyzing the digital content, the content system may determine that the digital content identifies specific objects, such as hand soap, multiple candles, among other examples. In some examples, adding the content category data as an additional input to the neural network model may alter the first memorability scores described above.

In some implementations, the input to the neural network model may include score settings in addition to the plurality of content data. For example, the content system may provide the plurality of content data and the score settings as input to the neural network model and may use the neural network model to determine first memorability scores in a manner similar to the manner described above. The score settings may include information identifying an exposure time for the digital content or a time interval between subsequent exposures of the digital content. In some examples, the score settings may be received from the user device. Additionally, or alternatively, the content system may be pre-configured with the score settings. Additionally, or alternatively, the content system may identify the score settings based on data (e.g., historical and/or current) regarding score settings that have been (and/or are being) used by the content system.

When the content system selects multiple neural network models, as described above, the content system may use a first neural network model to determine first memorability scores for the first user category, may use a second neural network model to determine first memorability scores for the second user category, and so on in a manner similar to the manner described above.

In some examples, the first memorability scores for the first user category may be associated with changes to the one or more features of the digital content (e.g., one or more changes to the contrast, one or more changes to the color, one or more combinations of changes to the contrast and the color, among other examples). In this regard, when generating the first memorability scores for the first user category, the neural network model may provide information identifying the changes associated with the first memorability scores.

In some examples, the content system may use the first memorability scores (for the first user category) to identify a change and/or a combination of changes (to the one or more features of the digital content) that will result in a highest likelihood of users of the first user category recalling the digital content after viewing the digital content. The content system may use the first memorability scores for the other user categories in a similar manner.

As shown in FIG. 1D, and by reference number 125, the content system may generate a final first memorability score for the digital content based on the first memorability scores for the plurality of content data. As an example, for the particular target user category, the content system may generate a final first memorability score for the digital content based on the first memorability scores (determined by the neural network model) for the particular target user category. In some examples, the content system may analyze the first memorability scores to identify a change to a feature or a combination of changes to the one or more features (of the digital content) that corresponds to a memorability score that satisfies a threshold. The threshold may be based on data (e.g., historical and/or current) regarding thresholds, based on information included in the request from the user device, among other examples.

In some implementations, the content system may generate the final first memorability score (for the digital content for the particular target user category) based on a first particular memorability score of the first memorability scores (determined by the neural network model). The first particular memorability score may be associated with a particular change to a particular feature of the digital content. For example, the first particular memorability score may be associated with a particular change to the contrast, a particular change to the color, or a particular change to the saturation, among other examples. In some examples, the first particular memorability score may correspond to a memorability score that is a highest score out of the first memorability scores (determined by the neural network model) and/or that satisfies the threshold.

In some implementations, the content system may generate the final first memorability score based on a second particular memorability score of the first memorability scores (determined by the neural network model). The second particular memorability score may be associated with a combination of changes to multiple features of the digital content. For example, the second particular memorability score may be associated with a combination of a particular change to the contrast, a particular change to the color, and/or a particular change to the size, among other examples. In some examples, the second particular memorability score may correspond to a memorability score that is a highest score out of the first memorability scores (determined by the neural network model) and/or that satisfies the threshold.

In some implementations in which the content system selects multiple neural network models, the content system may generate the final first memorability score based on a third particular memorability score of the first memorability scores (determined by the first neural network model) and a fourth particular memorability score of the first memorability scores (determined by the second neural network model). Assume that the third particular memorability score and the fourth particular memorability score both satisfy the threshold.

Assume that the third particular memorability score identifies a change for the contrast to a first contrast value and the fourth particular memorability score identifies a change for the contrast to a second contrast value. In some implementations, the content system may determine the final first memorability score based on a combination of the third particular memorability score and the fourth particular memorability score and, accordingly, determine an average of the first contrast value and the second contrast value as the change for the digital content.

In some implementations, the content system may determine a weighted combination of the third particular memorability score and the fourth particular memorability score. In this regard, a weight of a memorability score may be based on a portion of the first user category that corresponds to a user category for which a neural network model (that generated the memorability score) has been trained. Similarly, the content system may determine the change for the digital content based on a weighted average of the first contrast value and the second contrast value. The content system may generate a final first memorability score for the digital content, and the change for the digital content, for one or more other user categories in a manner similar to the manner described above.

As shown in FIG. 1E, and by reference number 130, the content system may process a plurality of areas of the plurality of content data, with a neural network model (e.g., the same neural network model described above or a different neural network model than as described above), to determine second memorability scores for the plurality of areas. The plurality of areas may include different sections of the digital content, such as a top-right area of the digital content, a bottom half area of the digital content, a center area of the digital content, an entire area of the digital content, among other examples. In some implementations, the content system may select a first neural network model for the first user category, select a second neural network model for the second user category, and so on in a manner similar to the manner described above in connection with FIG. 1B.

The content system may use the neural network model to determine the second memorability scores in a manner similar to the manner described above in connection with FIG. 1C. As an example, the content system may provide, as input to the neural network model, the plurality of content data, the content category data, and/or the score settings. The content system may use the neural network model to determine the second memorability scores for the plurality of areas (for the particular target user category) based on the input. The content system may use the second memorability scores to identify areas (of the digital content) that are likely to be remembered by users of the particular target user category after being viewed by the users. When the content system selects multiple neural network models, as described above, the content system may provide the plurality of content data, the content category data, and/or the score settings as an input to each of the multiple neural network models and each of the multiple neural network models may determine (or predict), as an output, respective second memorability scores for the plurality of content data.

The content system may use the second memorability scores to determine that a particular area (or multiple particular areas) of the digital content are most likely to be remembered by users of the particular target user category, such as the top-right area of the digital content, the bottom half area of the digital content, and so on. The content system may provide (e.g., to the user device) information identifying the areas (described above) as recommended areas for placing content (e.g., placing a logo, placing a graphical object, among other examples) in the digital content for the particular target user category.

In some implementations, when determining the second memorability scores for the particular target user category, the content system may use the neural network model to determine second memorability scores for one or more areas of the first content data. For instance, the second memorability scores (for the first content data) may indicate that the top-right area of the digital content is the most memorable area, that the bottom half area is a second most memorable area, that the center area is a third most memorable area, and so on. The content system may use the neural network model to determine second memorability scores for one or more areas of the second content data for the particular target user category. For instance, the second memorability scores (for the second content data) may indicate that a top-left area of the digital content is the most memorable area, that a bottom-left area is a second most memorable area, that the center area is a third most memorable area, and so on.

The content system may perform similar actions for one or more other content data of the plurality of content data. The content system may analyze the second memorability scores (determined for the plurality of content data for the particular target user category) to identify common memorable areas for the particular target user category. For example, the content system may determine that the top-right area of the digital content is the most memorable area, that the bottom half area is the second most memorable area, and that the center area is the third most memorable area. When the content system selects multiple neural network models, as described above, the content system may perform similar actions to identify the memorable areas for one or more other user categories (e.g., using a respective neural network model).

It has been described that the content system uses a neural network model to determine second memorability scores for the plurality of content data. In some implementations, the content system may use the neural network model to determine second memorability scores for a subset of the plurality of content data (e.g., for a subset of content data associated with highest first memorability scores, for a subset of content data associated with first memorability scores that satisfy a threshold, among other examples). In this case, the content system may conserve computing resources (e.g., processor resources, memory resources, networking resources) that would have otherwise been consumed to determine second memorability scores for all of the plurality of content data.

In some implementations, the second memorability scores may be represented via a heatmap indicating memorable areas of the plurality of areas. For example, the content system may generate a heatmap to indicate the memorable areas of the digital content for the particular target user category (e.g., using the second memorability scores determined by the neural network model). In some examples, a first color may indicate a first one or a first range of the second memorability scores, a second color may indicate a second one or a second range of the second memorability scores, and so on.

When the content system selects multiple neural network models for multiple user categories, as described above, the content system may generate multiple heatmaps (e.g., one heatmap per user category). For example, the content system may generate a first heatmap to indicate the memorable areas of the digital content for the first user category (e.g., using the second memorability scores determined by the first neural network model), generate a second heatmap to indicate the memorable areas for the second user category (e.g., using the second memorability scores determined by the second neural network model), and so on. In some implementations, the content system may combine the multiple heatmaps to generate a composite heatmap for the particular target user category. The content system may generate the composite heatmap using an image processing technique designed to compare and merge the multiple heatmaps. The composite heatmap may represent a combination (e.g., an average or a weighted average) of the multiple heatmaps.

As shown in FIG. 1F, and by reference number 135, the content system may perform one or more actions based on the final first memorability score, the first memorability scores, and/or the second memorability scores. In some implementations, the one or more actions include the content system providing the final first memorability score, the first memorability scores, and/or the second memorability scores for display. For example, the content system may provide information regarding the final first memorability score and/or the first memorability scores (e.g., for the particular target user category, for user categories that represent subsets of the particular target user category, among other examples) and/or provide information regarding the second memorability scores (e.g., for the particular target user category, for user categories that represent subsets of the particular target user category, among other examples) for display via a user interface provided by the user device.

The user interface may enable a user to view the final first memorability score (e.g., for the particular target user category, for user categories that represent subsets of the particular target user category, among other examples), the first memorability scores (e.g., for the particular target user category, for user categories that represent subsets of the particular target user category, among other examples) and/or the second memorability scores (e.g., for the particular target user category, for user categories that represent subsets of the particular target user category, among other examples) in conjunction with data used to generate such memorability scores. The data may include data identifying the particular target user category, data identifying the user categories that represent subsets of the particular target user category, data identifying the exposure time, data identifying the time interval between subsequent exposures of the digital content, among other examples.

In some implementations, with respect to the final first memorability score and/or the first memorability scores, the content system may provide information identifying one or more changes to the one or more features of the digital content. With respect to the second memorability scores, the content system may provide information identifying recommended areas (in the digital content) for placing content (e.g., placing a logo, placing a graphical object, among other examples) for the particular target user category.

In some examples, the content system may provide, for display, information identifying memorability scores with respect to different groups of the particular target user category. For example, the content system may provide a memorability score for a first group of male users (e.g., a first age range of male users), a memorability score for a second group of male users (e.g., a second age range of male users), and so on.

In some examples, the content system may provide, for display, information identifying memorability scores for the particular target user category with respect to a feature of the digital content. For example, for female users, the content system may provide a memorability score for a first contrast value of the digital content, a memorability score for a second contrast value of the digital content, a memorability score for a third contrast value of the digital content, and so on. The content system may provide similar information for other features of the digital content (e.g., a color, a saturation, a size, among other examples).

In some examples, the content system may provide, for display, information identifying memorability scores for the particular target user category with respect to an exposure time for the digital content. For example, for male users of ages 20-30, the content system may provide a memorability score for a first exposure time of the digital content, a memorability score for a second exposure time of the digital content, and so on. The content system may provide similar information for a time interval between subsequent exposures of the digital content. In some implementations, the content system may provide, to the user device, the information (described above) in various formats (e.g., a graph, a chart, among other examples). In some examples, the content system may provide the information (described above) to enable a comparison (of memorability scores and/or associated changes to the one or more features of the digital content) with respect to the particular target user category. The content system may provide the information to the user device to enable the user device to modify the one or more features of the digital content to improve a memorability of the digital content for the particular target user category and/or to cause the content system to modify the one or more features of the digital content.

In some implementations, the one or more actions include the content system modifying one of the one or more of the features of the digital content based on the final first memorability score, the first memorability scores, and/or the second memorability scores. For example, the content system may modify the feature, based on the final first memorability score and/or the first memorability scores, to generate modified digital content and provide the modified digital content to the user device (e.g., via the user interface). Additionally, or alternatively, the content system may modify the digital content to move a location of an object (e.g., a logo or another type of object) within the digital content based on the second memorability scores, and provide the modified digital content to the user device (e.g., via the user interface). In this case, the content system may conserve computing resources (e.g., processor resources, memory resources, networking resources) that would have otherwise been consumed by modifying different features of the digital content that would not improve the memorability of the digital content for the particular target user category or that would decrease the memorability of the digital content for the particular target user category.

In some implementations, the one or more actions include the content system causing the digital content to be implemented based on the final first memorability score, the first memorability scores, and/or the second memorability scores. For example, for the particular target user category, the content system may identify the one or more changes (to the one or more features of the digital content) associated with the final first memorability score and/or the first memorability scores and may modify the one or more features in accordance with the one or more changes to generate modified digital content. Additionally, or alternatively, the content system may identify one or more areas (e.g., one or more memorable areas) of the digital content associated with the second memorability scores and modify a location of one or more objects within the one or more areas of the digital content to generate modified digital content. In this case, the content system may conserve computing resources (e.g., processor resources, memory resources, networking resources) that would have otherwise been consumed by modifying different features of the digital content that would not improve the memorability of the digital content for the particular target user category or that would decrease the memorability of the digital content for the particular target user category.

The content system may cause the modified digital content to be provided to one or more user devices (e.g., associated with users of the particular target user category), cause the modified digital content to be provided to one or more server devices associated with one or more websites (e.g., that target the users), cause the modified digital content to be provided to one or more server devices associated with one or more applications (e.g., that target the users) to cause the modified digital content to be provided as part of content of the one or more applications, cause the modified digital content to be provided to one or more automated devices to cause the one or more automated devices to print the modified digital content and deliver the printed modified digital content to the users, among other examples.

In some implementations, the one or more actions include the content system providing, for display, a suggested change to one of the one or more of the features of the digital content based on the final first memorability score, the first memorability scores, and/or the second memorability scores. In some implementations, the content system may identify one or more changes to one or more of the features associated with the final first memorability score and/or the first memorability scores (e.g., determined for the particular target user category). Additionally, or alternatively, the content system may identify one or more memorable areas (of the digital content) associated with the second memorability scores (e.g., determined for the particular target user category). The content system may provide, to the user device for display, information identifying the one or more changes and/or information identifying the one or more memorable areas as suggested changes to improve a memorability score (for the digital content) for the particular target user category.

In some instances, the information identifying the one or more changes may include information identifying a measure of increase of memorability (for the particular target user category) based on the one or more changes. For example, the content system may indicate that an increase of the contrast of the digital content (e.g., a five percent increase) may increase a memorability score (e.g., from seventy percent to eighty percent) for the particular target user category.

In some implementations, the one or more actions include the content system receiving a change to one of the one or more of the features of the digital content based on the final first memorability score, the first memorability scores, and/or the second memorability scores and implementing the change. For example, the content system may receive information identifying the change from the user device. The content system may implement the change to the one of the one or more features and generate modified digital content in a manner similar to the manner described above. In some implementations, the content system may provide the modified digital content to the user device. In some implementations, the content system may recalculate the final first memorability score, the first memorability scores, and/or the second memorability scores based on the change to one of the one or more features of the digital content in a manner similar to the manner described above.

In some implementations, the one or more actions include the content system retraining one or more of the plurality of neural network models based on the final first memorability score, the first memorability scores, and/or the second memorability scores. The content system may utilize the final first memorability score, the first memorability scores, and/or the second memorability scores as additional training data for retraining the one or more of the plurality of neural network models, thereby increasing the quantity of training data available for training the one or more of the plurality of neural network models and improving an accuracy of the one or more of the plurality of neural network models.

Accordingly, the content system may conserve computing resources associated with identifying, obtaining, and/or generating historical data for training the one or more of the plurality of neural network models relative to other systems for identifying, obtaining, and/or generating historical data for training machine learning models. Additionally, or alternatively, utilizing the final first memorability score, the first memorability scores, and/or the second memorability scores as additional training data improves the accuracy and efficiency of the neural network model, thereby conserving computing resources (e.g., processing resources, memory resources, communication resources, and/or the like), networking resources, and/or other resources that would have otherwise been used if the neural network model was not updated.

By calculating memorability scores as described herein, the content system conserves computing resources, networking resources, and/or other resources that would otherwise have been have been consumed by using one or more image processing techniques to generate images that are not memorable, using the one or more image processing techniques to alter the images when the images are not memorable, using one or more image processing techniques to generate additional images, searching sources of digital content for images that are memorable, among other examples.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram illustrating an example 200 of training and using a machine learning model (e.g., the neural network model) in connection with determining content placement based on memorability. The machine learning model training and usage described herein may be performed using a machine learning system. The machine learning system may include or may be included in a computing device, a server, a cloud computing environment, among other examples, such as the content system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the content system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the content system. For example, the machine learning system may identify a feature set (e.g., one or more features and/or feature values) by extracting the feature set from structured data, by performing natural language processing to extract the feature set from unstructured data, by receiving input from an operator, among other examples.

As an example, a feature set for a set of observations may include a first feature of a digital content, a second feature of content data, a third feature of areas, and so on. As shown, for a first observation, the first feature may have a value of digital content 1, the second feature may have a value of content data 1, the third feature may have a value of areas 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, among other examples), may represent a variable having a Boolean value, among other examples. A target variable may be associated with a target variable value, and a target variable value may be specific to an observation. In example 200, the target variable is a memorability score, which has a value of memorability score 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, among other examples. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of digital content X, a second feature of content data X, a third feature of areas X, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, among other examples, such as when unsupervised learning is employed.

As an example, the trained machine learning model 225 may predict a value of memorability score X for the target variable of the memorability score for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a digital content cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a content data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, among other examples), may be based on whether a target variable value satisfies one or more thresholds (e.g., whether the target variable value is greater than a threshold, is less than a threshold, is equal to a threshold, falls within a range of threshold values, among other examples), may be based on a cluster in which the new observation is classified, among other examples.

In this way, the machine learning system may apply a rigorous and automated process to determine content placement based on memorability. The machine learning system enables recognition and/or identification of tens, hundreds, thousands, or millions of features and/or feature values for tens, hundreds, thousands, or millions of observations, thereby increasing accuracy and consistency and reducing delay associated with determining content placement based on memorability relative to requiring computing resources to be allocated for tens, hundreds, or thousands of operators to manually generate initiative plans.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a content system 301, which may include one or more portions of and/or may execute within a cloud computing system 302. The cloud computing system 302 may include one or more portions 303-313, as described in more detail below. As further shown in FIG. 3, environment 300 may include a network 320 and/or a user device 330. Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of computing hardware 303 to create the one or more virtual computing systems 306. Using virtualization, the resource management component 304 enables a single computing device (e.g., a computer, a server, among other examples) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, among other examples) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

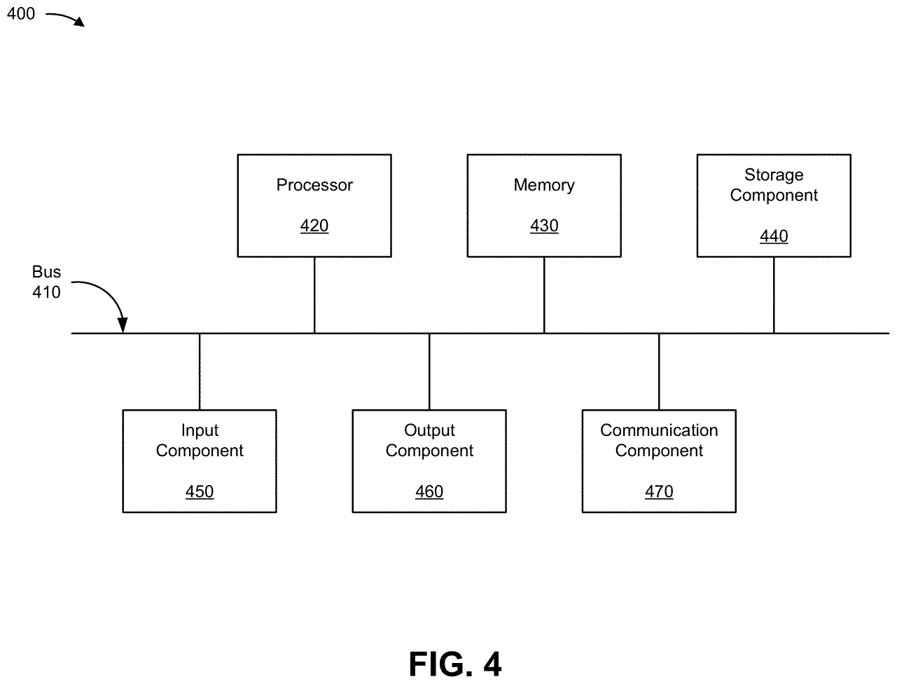

Although the content system 301 may include one or more portions 303-313 of the cloud computing system 302, may execute within the cloud computing system 302, and/or may be hosted within the cloud computing system 302, in some implementations, the content system 301 may not be cloud-based (e.g., may be implemented outside of a cloud computing system) or may be partially cloud-based. For example, the content system 301 may include one or more devices that are not part of the cloud computing system 302, such as device 400 of FIG. 4, which may include a standalone server or another type of computing device. The content system 301 may perform one or more operations and/or processes described in more detail elsewhere herein.

Network 320 includes one or more wired and/or wireless networks. For example, network 320 may include a cellular network, a public land mobile network (PLMN), a local area network (LAN), a wide area network (WAN), a private network, the Internet, among other examples, and/or a combination of these or other types of networks. The network 320 enables communication among the devices of environment 300.

User device 330 includes one or more devices capable of receiving, generating, storing, processing, and/or providing information, as described elsewhere herein. User device 330 may include a communication device. For example, user device 330 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. User device 330 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of one or more devices of FIG. 3. The one or more devices may include a device 400, which may correspond to content system 301 and/or user device 330. In some implementations, content system 301 and/or user device 330 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random-access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid-state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, an actuator, among other examples. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, an antenna, among other examples.

Device 400 may perform one or more processes described herein. For example, a non-transitory computer-readable medium (e.g., memory 430 and/or storage component 440) may store a set of instructions (e.g., one or more instructions, code, software code, program code, among other examples) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

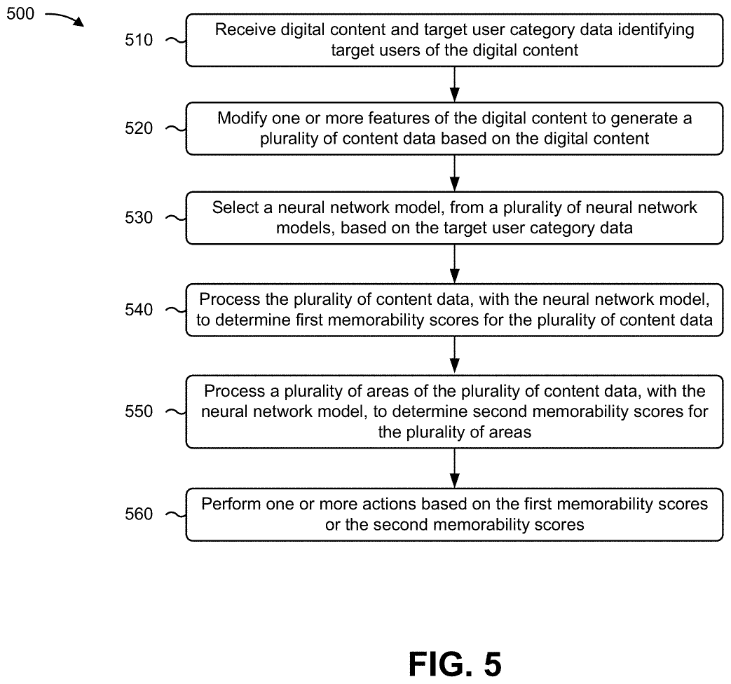

FIG. 5 is a flowchart of an example process 500 for utilizing neural network models to determine content placement based on memorability. In some implementations, one or more process blocks of FIG. 5 may be performed by a device (e.g., content system 301). In some implementations, one or more process blocks of FIG. 5 may be performed by another device or a group of devices separate from or including the device, such as a user device (e.g., user device 330). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving digital content and target user category data identifying target users of the digital content (block 510). For example, the device may receive digital content and target user category data identifying target users of the digital content, as described above.

As further shown in FIG. 5, process 500 may include modifying one or more features of the digital content to generate a plurality of content data based on the digital content (block 520). For example, the device may modify one or more features of the digital content to generate a plurality of content data based on the digital content, as described above.

As further shown in FIG. 5, process 500 may include selecting a neural network model, from a plurality of neural network models, based on the target user category data (block 530). For example, the device may select a neural network model, from a plurality of neural network models, based on the target user category data, as described above.

As further shown in FIG. 5, process 500 may include processing the plurality of content data, with the neural network model, to determine first memorability scores for the plurality of content data (block 540). For example, the device may process the plurality of content data, with the neural network model, to determine first memorability scores for the plurality of content data, as described above.

As further shown in FIG. 5, process 500 may include processing a plurality of areas of the plurality of content data, with the neural network model, to determine second memorability scores for the plurality of areas (block 550). For example, the device may process a plurality of areas of the plurality of content data, with the neural network model, to determine second memorability scores for the plurality of areas, as described above.

As further shown in FIG. 5, process 500 may include performing one or more actions based on the first memorability scores or the second memorability scores (block 560). For example, the device may perform one or more actions based on the first memorability scores or the second memorability scores, as described above.

Process 500 may include additional implementations, such as any single implementation or any combination of implementations described below and/or in connection with one or more other processes described elsewhere herein.

In a first implementation, the digital content includes one or more of an image, a video, or textual information.

In a second implementation, alone or in combination with the first implementation, modifying the one or more features of the digital content to generate the plurality of content data based on the digital content includes one or more of modifying a contrast of the digital content to generate first content data, modifying a color of the digital content to generate second content data, modifying a saturation of the digital content to generate third content data, modifying a size of the digital content to generate fourth content data, or modifying a position of the digital content to generate fifth content data, wherein the plurality of content data includes one or more of the first content data, the second content data, the third content data, the fourth content data, or the fifth content data.

In a third implementation, alone or in combination with one or more of the first and second implementations, the target user category data includes data identifying one or more of ages of the target users of the digital content, genders of the target users of the digital content, job descriptions of the target users of the digital content, levels of education of the target users of the digital content, or levels of income of the target users of the digital content.

In a fourth implementation, alone or in combination with one or more of the first through third implementations, processing the plurality of content data, with the neural network model, to determine the first memorability scores for the plurality of content data includes processing the plurality of content data and score settings, with the neural network model, to determine the first memorability scores for the plurality of content data, wherein the score settings include at least one of an exposure time for the digital content or a time interval between two exposures of the digital content.

In a fifth implementation, alone or in combination with one or more of the first through fourth implementations, processing the plurality of areas of the plurality of content data, with the neural network model, to determine the second memorability scores for the plurality of areas includes processing the plurality of areas and score settings, with the neural network model, to determine the second memorability scores for the plurality of areas, wherein the score settings include at least one of an exposure time for the digital content or a time interval between two exposures of the digital content.

In a sixth implementation, alone or in combination with one or more of the first through fifth implementations, the second memorability scores are represented via a heatmap indicating memorable areas of the plurality of areas.

In a seventh implementation, alone or in combination with one or more of the first through sixth implementations, processing the plurality of content data, with the neural network model, to determine the first memorability scores for the plurality of content data includes processing the plurality of content data and category data, with the neural network model, to determine the first memorability scores for the plurality of content data, wherein the category data includes data identifying a category of the digital content.

In an eighth implementation, alone or in combination with one or more of the first through seventh implementations, processing the plurality of areas of the plurality of content data, with the neural network model, to determine the second memorability scores for the plurality of areas includes processing the plurality of areas and category data, with the neural network model, to determine the second memorability scores for the plurality of areas, wherein the category data includes data identifying a category of the digital content.

In a ninth implementation, alone or in combination with one or more of the first through eighth implementations, performing the one or more actions includes one or more of providing the first memorability scores or the second memorability scores for display, modifying one of the one or more features of the digital content based on the first memorability scores or the second memorability scores, or causing the digital content to be implemented based on the first memorability scores or the second memorability scores.

In a tenth implementation, alone or in combination with one or more of the first through ninth implementations, performing the one or more actions includes one or more of providing for display a suggested change to one of the one or more features of the digital content based on the first memorability scores or the second memorability scores, or retraining one or more of the plurality of neural network models based on the first memorability scores or the second memorability scores.

In an eleventh implementation, alone or in combination with one or more of the first through tenth implementations, performing the one or more actions includes receiving a change to one of the one or more features of the digital content based on the first memorability scores or the second memorability scores, and implementing the change to one of the one or more features of the digital content.

In a twelfth implementation, alone or in combination with one or more of the first through eleventh implementations, performing the one or more actions includes implementing a change to one of the one or more features of the digital content based on the first memorability scores or the second memorability scores, and recalculating the first memorability scores and the second memorability scores based on the change to one of the one or more features of the digital content.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, among other examples, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, among other examples), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, digital content and target user category data identifying target users of the digital content;
modifying, by the device, one or more features of the digital content to generate a plurality of content data based on the digital content;
selecting, by the device, a neural network model, from a plurality of neural network models, based on the target user category data;
processing, by the device, the plurality of content data, with the neural network model, to determine first memorability scores for the plurality of content data;
processing, by the device, a plurality of areas of the plurality of content data, with the neural network model, to determine second memorability scores for the plurality of areas; and
performing, by the device, one or more actions based on the first memorability scores or the second memorability scores.

2. The method of claim 1, wherein the digital content includes one or more of:
an image,
a video, or
textual information.

3. The method of claim 1, wherein modifying the one or more features of the digital content to generate the plurality of content data based on the digital content comprises one or more of:
modifying a contrast of the digital content to generate first content data,
modifying a color of the digital content to generate second content data,
modifying a saturation of the digital content to generate third content data,
modifying a size of the digital content to generate fourth content data, or
modifying a position of the digital content to generate fifth content data,
wherein the plurality of content data includes one or more of the first content data, the second content data, the third content data, the fourth content data, or the fifth content data.

4. The method of claim 1, wherein the target user category data includes data identifying one or more of:
ages of the target users of the digital content,
genders of the target users of the digital content,
job descriptions of the target users of the digital content,
levels of education of the target users of the digital content, or
levels of income of the target users of the digital content.

5. The method of claim 1, wherein processing the plurality of content data, with the neural network model, to determine the first memorability scores for the plurality of content data comprises:
processing the plurality of content data and score settings, with the neural network model, to determine the first memorability scores for the plurality of content data,
wherein the score settings include at least one of an exposure time for the digital content or a time interval between two exposures of the digital content.

6. The method of claim 1, wherein processing the plurality of areas of the plurality of content data, with the neural network model, to determine the second memorability scores for the plurality of areas comprises:
processing the plurality of areas and score settings, with the neural network model, to determine the second memorability scores for the plurality of areas,
wherein the score settings include at least one of an exposure time for the digital content or a time interval between two exposures of the digital content.

7. The method of claim 1, wherein the second memorability scores are represented via a heatmap indicating memorable areas of the plurality of areas.

8. A device, comprising:
one or more memories; and
one or more processors, communicatively coupled to the one or more memories, configured to:
receive digital content and target user category data identifying target users of the digital content;
modify one or more features of the digital content to generate a plurality of content data based on the digital content,
wherein the one or more features include one or more of:
a contrast of the digital content,
a color of the digital content,
a saturation of the digital content,
a size of the digital content, or
a position of the digital content;
select a neural network model, from a plurality of neural network models, based on the target user category data;
process the plurality of content data, with the neural network model, to determine first memorability scores for the plurality of content data;
process a plurality of areas of the plurality of content data, with the neural network model, to determine second memorability scores for the plurality of areas; and
perform one or more actions based on the first memorability scores or the second memorability scores.

9. The device of claim 8, wherein the one or more processors, when processing the plurality of content data, with the neural network model, to determine the first memorability scores for the plurality of content data, are configured to:
process the plurality of content data and content category data, with the neural network model, to determine the first memorability scores for the plurality of content data,
wherein the content category data includes data identifying a category of the digital content.

10. The device of claim 8, wherein the one or more processors, when processing the plurality of areas of the plurality of content data, with the neural network model, to determine the second memorability scores for the plurality of areas, are configured to:
process the plurality of areas and content category data, with the neural network model, to determine the second memorability scores for the plurality of areas,
wherein the content category data includes data identifying a category of the digital content.

11. The device of claim 8, wherein the one or more processors, when performing the one or more actions, are configured to one or more of:
provide the first memorability scores or the second memorability scores for display;
modify one of the one or more features of the digital content based on the first memorability scores or the second memorability scores; or
cause the digital content to be implemented based on the first memorability scores or the second memorability scores.

12. The device of claim 8, wherein the one or more processors, when performing the one or more actions, are configured to one or more of:
provide for display a suggested change to one of the one or more features of the digital content based on the first memorability scores or the second memorability scores; or
retrain one or more of the plurality of neural network models based on the first memorability scores or the second memorability scores.

13. The device of claim 8, wherein the one or more processors, when performing the one or more actions, are configured to:
receive a change to one of the one or more features of the digital content based on the first memorability scores or the second memorability scores; and
implement the change to one of the one or more features of the digital content.

14. The device of claim 8, wherein the one or more processors, when performing the one or more actions, are configured to:
implement a change to one of the one or more features of the digital content based on the first memorability scores or the second memorability scores; and
recalculate the first memorability scores and the second memorability scores based on the change to one of the one or more features of the digital content.

15. A non-transitory computer-readable medium storing a set of instructions, the set of instructions comprising:
one or more instructions that, when executed by one or more processors of a device, cause the device to:
receive digital content and target user category data identifying target users of the digital content;
modify one or more features of the digital content to generate a plurality of content data based on the digital content;
select a neural network model, from a plurality of neural network models, based on the target user category data;
process the plurality of content data, score settings, and category data, with the neural network model, to determine first memorability scores for the plurality of content data,
wherein the score settings include at least one of an exposure time for the digital content or a time interval between two exposures of the digital content, and
wherein the category data includes data identifying a category of the digital content;
process a plurality of areas of the plurality of content data, the score settings, and the category data, with the neural network model, to determine second memorability scores for the plurality of areas; and
perform one or more actions based on the first memorability scores or the second memorability scores.

16. The non-transitory computer-readable medium of claim 15, wherein the one or more instructions, that cause the device to modify the one or more features of the digital content to generate the plurality of content data based on the digital content, cause the device to:
modify a contrast of the digital content to generate first content data,
modify a color of the digital content to generate second content data,
modify a saturation of the digital content to generate third content data,
modify a size of the digital content to generate fourth content data, or
modify a position of the digital content to generate fifth content data,
wherein the plurality of content data includes one or more of the first content data, the second content data, the third content data, the fourth content data, or the fifth content data.

17. The non-transitory computer-readable medium of claim 15, wherein the second memorability scores are represented via a heatmap indicating memorable areas of the plurality of areas.

18. The non-transitory computer-readable medium of claim 15, wherein the one or more instructions, that cause the device to perform the one or more actions, cause the device to one or more of:
provide the first memorability scores or the second memorability scores for display;
modify one of the one or more features of the digital content based on the first memorability scores or the second memorability scores;
cause the digital content to be implemented based on the first memorability scores or the second memorability scores;
provide for display a suggested change to one of the one or more features of the digital content based on the first memorability scores or the second memorability scores; or
retrain one or more of the plurality of neural network models based on the first memorability scores or the second memorability scores.

19. The non-transitory computer-readable medium of claim 15, wherein the one or more instructions, that cause the device to perform the one or more actions, cause the device to:
receive a change to one of the one or more features of the digital content based on the first memorability scores or the second memorability scores; and
implement the change to one of the one or more features of the digital content.

20. The non-transitory computer-readable medium of claim 15, wherein the one or more instructions, that cause the device to perform the one or more actions, cause the device to:
implement a change to one of the one or more features of the digital content based on the first memorability scores or the second memorability scores; and
recalculate the first memorability scores and the second memorability scores based on the change to one of the one or more features of the digital content.
